(19) United States
(12) Patent Application Publication
(10) Pub. No.: US 2025/0175310 A1
(43) Pub. Date: May 29, 2025

(54) SYSTEMS AND METHODS FOR COVERAGE ENHANCEMENT IN NON TERRESTRIAL NETWORK

(71) Applicant: ZTE CORPORATION, Shenzhen (CN)

(72) Inventors: Yachao YIN, Shenzhen (CN); Nan ZHANG, Shenzhen (CN); Fangyu CUI, Shenzhen (CN); Junli LI, Shenzhen (CN)

(73) Assignee: ZTE CORPORATION, Shenzhen (CN)

(21) Appl. No.: 19/042,073

(22) Filed: Jan. 31, 2025

Related U.S. Application Data
(63) Continuation of application No. PCT/CN2023/078728, filed on Feb. 28, 2023.

(51) Int. Cl. H04L 5/00; H04W 8/22

(52) U.S. Cl. CPC H04L 5/0078; H04L 5/0051; H04W 8/22

(57) ABSTRACT

Presented are systems and methods for coverage enhancement in non-terrestrial network (NTN). A wireless communication device may send assistance information of the wireless communication device that is indicative of a time domain window (TDW) size of the wireless communication device for bundling of demodulation reference signals (DMRSes) to a wireless communication node. The wireless communication device may send an uplink (UL) transmission according to the bundling of DMRSes to the wireless communication node.

### CROSS-REFERENCE TO RELATED APPLICATION

This application claims the benefit of priority under 35 U.S.C. § 120 as a continuation of PCT Patent Application No. PCT/CN2023/078728, filed on Feb. 28, 2023, the disclosure of which is incorporated herein by reference in its entirety.

### TECHNICAL FIELD

The disclosure relates generally to wireless communications, including but not limited to systems and methods for coverage enhancement in non-terrestrial network (NTN).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A wireless communication device (e.g., a user equipment (UE)) may send assistance information of the wireless communication device that is indicative of a time domain window (TDW) size of the wireless communication device for bundling of demodulation reference signals (DMRSes) (e.g., a DRMS TDW or can be used to determine the DMRS TDW) to a wireless communication node (e.g., a base station (BS)). The wireless communication device may send an uplink (UL) transmission according to the bundling of DMRSes to the wireless communication node.

In some embodiments, the assistance information may include at least one of: capability information of the wireless communication device that can be indicative of the TDW size of the wireless communication device for the bundling of DMRSes; or an indication of the TDW size for the bundling of DMRSes. The capability information may include, for all scenarios or for each of one or more scenarios, a respective indication of at least one of: whether the wireless communication device supports segment-specific compensation (e.g., specific to each segment) or pre-compensation (e.g., on a per-segment basis) using at least one of: timing advance (TA) or frequency adjustment; whether the wireless communication device supports the bundling of DMRSes across multiple segments of the UL transmission, over a length (e.g., a time duration) that is indicated (e.g., configured) by the wireless communication node; whether the wireless communication device supports the bundling of DMRSes; a maximum TDW size without consideration of/independent of/regardless of the segment-specific compensation or pre-compensation; whether the wireless communication device supports a TDW size for the bundling of DMRSes (e.g., DMRS TDW or DMRS bundling size), that is longer than a segment's length of compensation or pre-compensation; or a maximum TDW size when the wireless communication device supports a TDW size for the bundling of DMRSes, that is longer than a segment's length of compensation or pre-compensation.

In some embodiments, sending the assistance information may comprise sending the assistance information using one or more transmissions. The one or more transmissions may comprise at least one of: a radio resource control (RRC) signaling or a medium access control control element (MAC CE) signaling. The indication of the TDW size for the bundling of DMRSes may include at least one of: a TDW size for the bundling of DMRSes for all scenarios; a scaling factor with respect to a segment's length, wherein the TDW size for the bundling of DMRSes is a product of the scaling factor and the segment's length; a first offset value (e.g., a differential value) with respect to a segment's length, wherein the TDW size for the bundling of DMRSes is a sum of the first offset value and the segment's length; or a second offset value with respect to the maximum TDW size without consideration of the segment-specific compensation or pre-compensation, wherein the TDW size for the bundling of DMRSes is a sum of the second offset value and the maximum TDW size without consideration of the segment-specific compensation or pre-compensation.

In some embodiments, the wireless communication device may send at least a portion of the assistance information after receiving a configuration of segments of the UL transmission, or before receiving the configuration of the segments, to the wireless communication node. In certain embodiments, the configuration of the segments can be determined according to at least some portion of the assistance information.

In some embodiments, the wireless communication device may determine the TDW size for the bundling of DMRSes, according to at least one of: the assistance information (e.g., which can indicate a time duration of UE capability), a nominal TDW size configured by the wireless communication node; or a segment's length of compensation or pre-compensation, configured by the wireless communication node. The wireless communication device may receive a configuration of segments of the UL transmission (e.g., a configuration of segment length(s)) from the wireless communication node. The wireless communication device may perform compensation or pre-compensation for the uplink transmission for each of the segments (e.g., specific to each segment).

In some embodiments, the wireless communication device may receive, from the wireless communication node, at least one of: a confirmation to use at least a portion of the assistance information from the wireless communication device, in relation to the UL transmission; a confirmation to use the TDW size indicated in the assistance information, in relation to the UL transmission; or an indication of the TDW size, that is different from or same as the TDW size indicated in the assistance information, to use in relation to the UL transmission. The wireless communication device may transmit the UL transmission according to the TDW size (e.g., using the TDW size, or in relation to/with the TDW size) to the wireless communication node. When the TDW size indicated by wireless communication device is larger than a segment's length configured by the wireless communication node, the wireless communication device can be to ensure consistency between adjacent segments of the UL transmission that are within a corresponding TDW (e.g., in compensation/pre-compensation).

In some embodiments, the wireless communication node (e.g., a BS) may receive assistance information of the wireless communication device that can be indicative of a time domain window (TDW) size of the wireless communication device for bundling of demodulation reference signals (DMRSes) from a wireless communication device (e.g., a UE). The wireless communication node may receive an uplink (UL) transmission according to the bundling of DMRSes from the wireless communication device.

In some embodiments, a wireless communication device may compare a metric (e.g., a reference signal receiving power (RSRP), a reference signal receiving quality (RSRQ), an elevation angle, or a distance) relative to one or more thresholds; and at least one of: determining, by the wireless communication device according to the comparing, whether and/or what repetition of a transmission (e.g., hybrid automatic repeat request-acknowledgment (HARQ-ACK) for msg4) in a physical uplink control channel to the wireless communication node, is desired; determining, by the wireless communication device according to the comparing, whether to indicate to the wireless communication node whether and/or what repetition is desired for the transmission; or sending, by the wireless communication device to the wireless communication node, an indication of whether and/or what repetition is desired for the transmission.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example non-terrestrial network (NTN), in accordance with some embodiments of the present disclosure;

FIG. 4 illustrates segmented pre-compensation, in accordance with some embodiments of the present disclosure; and

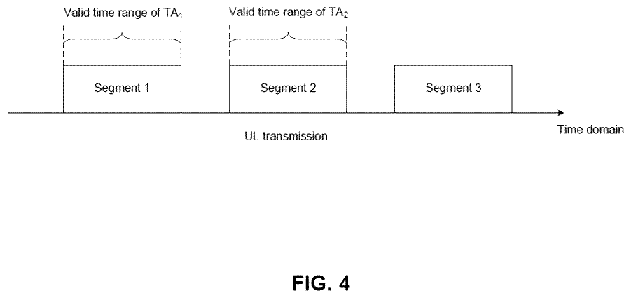

FIG. 5 illustrates a flow diagram for coverage enhancement in non-terrestrial network (NTN), in accordance with an embodiment of the present disclosure.

### DETAILED DESCRIPTION

### 1. Mobile Communication Technology and Environment

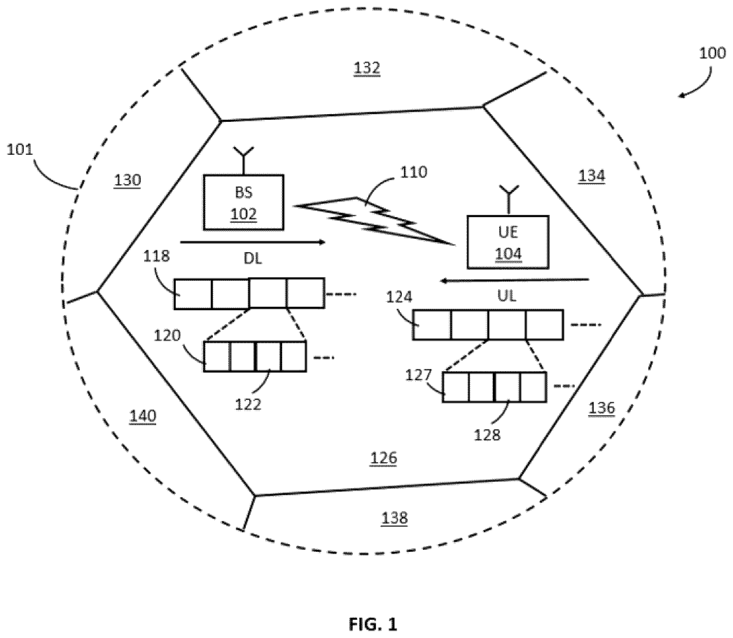

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

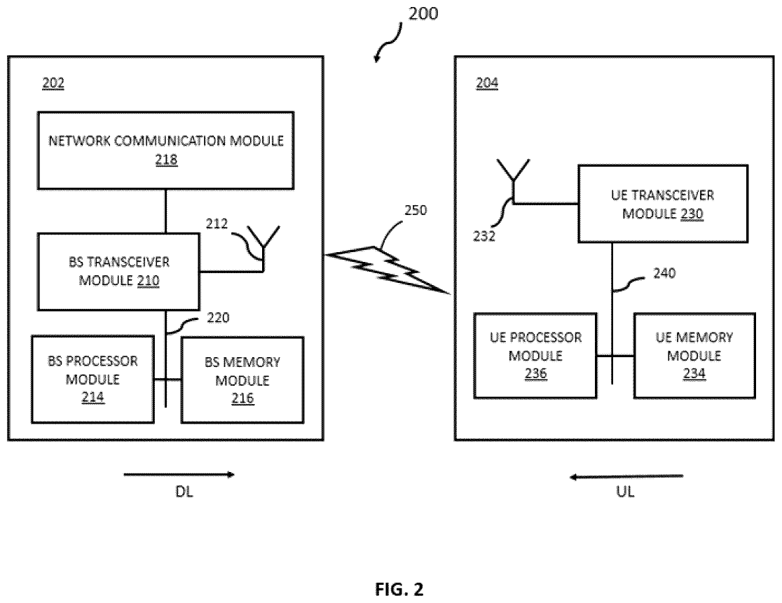

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (cNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Coverage Enhancement in Non-Terrestrial Network (NTN)

In order to mitigate performance loss due to a large distance between UE and satellite, coverage enhancement for non-terrestrial network (NTN) can be supported. An enhancement specified for terrestrial network (TN) can be considered as baseline (e.g., demodulation reference signal (DMRS) bundling and joint channel estimation (JCE)). However, due to high mobility of a satellite in NTN, a timing drift can be fast and a timing advance (TA) pre-compensation value may need to be adjusted frequently. In this scenario, a length of DMRS bundling may be shorter than a pre-compensation segment since a DMRS with different TA pre-compensation may cause phase discontinuity between segments. If the phase difference is larger than a tolerable range, the DMRS in different segments cannot be bundled. In this disclosure, with consideration of an advanced user equipment (UE) implementation to enlarge/extend time domain window (TDW) that extends across/over multiple uplink (UL) segments, coverage enhancement in non-terrestrial network (NTN) can be performed (e.g., how to maximize a DMRS bundling size).

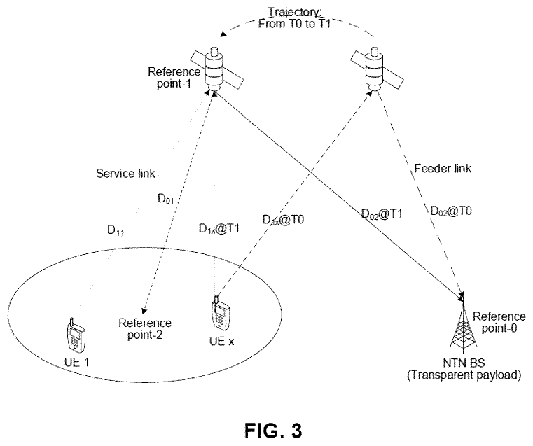

FIG. 3 illustrates an example representation of a NTN (e.g., a transparent NTN). In some embodiments, the link between a UE and a satellite may be a service link. The link between a base station (BS) and a satellite may be a feeder link. The feeder link can be common for all UEs within the same cell.

In TN systems, methods for coverage enhancement may include: repetition and/or joint channel estimation (JCE). For the repetition method, a transmitter can repetitively transmit a message for a period of time. A receiver can combine the repetition of the transmissions and may increase the performance of decoding. For the joint channel estimation (JCE) method, reference signals (RSs) at different time instances can be used jointly to estimate a channel. The JCE may provide a better estimation of channel and/or better decoding performance. In the JCE method, the DMRSes can be bundled (e.g., considered or measured together as a group/bundle), as these bundled DMRSes can be considered quasi colocation (QCL) in the channel estimation.

Segmented pre-compensation may apply different pre-compensation of timing advances (TAs) and/or frequency offsets for different components/segments of a single uplink (UL) transmission (e.g., segmented pre-compensation). In order to avoid the timing offset/frequency offset (TO/FO) exceeding a tolerable range, the pre-compensated TA and/or Doppler may be adjusted after a period of time to mitigate the timing and/or frequency drift caused by satellite mobility. When the adjustment period is shorter than a total time of a single transmission (with multiple repetitions), the transmission may be divided into multiple segments. Each segment may apply or be subject to a respective TA and/or Doppler pre-compensation value.

Although segmented pre-compensation can be beneficial to maintain power consistency and phase continuity, the segmented pre-compensation can be restricted by UE capability and/or a DMRS bundling size (e.g., actual TDW size may be shorter than a duration of UL segment). In other words, if an advanced UE supports DMRS bundling that crosses segmented pre-compensation with the UE's implementation, a large TDW size can be achieved at a gNB. Otherwise, an insufficient TDW size of DMRS bundling can hardly provide significant gain for joint channel estimation.

### Implementation Example 1: Demodulation Reference Signal (DMRS) Bundling with a Consideration of UE Capability Signaling

In new radio (NR), demodulation reference signals (DMRSes) bundling can be considered as a method to enhance coverage performance. In an uplink (UL) transmission, the DMRSes in multiple slots can be bundled. The DMRSes within the same bundle can be thought to be QCLed. In such case, joint channel estimation (JCE) across these slots can be performed, which improves the channel estimation performance. A detection performance of the data can also be improved accordingly. A larger DMRS bundle may better improve the JCE performance.

However, if segmented pre-compensation is performed, a DMRS bundling size may be reduced since a limited capability UE cannot maintain power consistency and phase continuity between the UL segments. If an advanced UE is capable of supporting an expected time domain window (TDW) that crosses UL transmission segments with its implementation, a BS can determine a large DMRS bundling size with knowledge about the UE's capability via capability (or assistance information) signaling.

In order to help a BS determine a DMRS bundling TDW size, the UE may send assistance information of the UE that is indicative of a time domain window (TDW) size of the UE for bundling of demodulation reference signals (DMRSes) to the BS. The UE may send an uplink (UL) transmission according to the bundling of DMRSes. Sending the assistance information may comprise sending the assistance information using one or more transmissions. The one or more transmissions may comprise at least one of: a radio resource control (RRC) signaling or a medium access control control element (MAC CE) signaling.

The assistance information may indicate at least one of following capability to the BS: (1) whether the UE supports segment-specific compensation (e.g., specific to each segment) or pre-compensation (e.g., on a per-segment basis) using at least one of: timing advance (TA) or frequency adjustment; (2) whether the UE supports the bundling of DMRSes across multiple segments of the UL transmission, over a length (e.g., a time duration) that is indicated (e.g., configured) by the BS; (3) whether the UE supports the bundling of DMRSes; a maximum TDW size without consideration of/independent of/regardless of the segment-specific compensation or pre-compensation; (4) whether the UE supports a TDW size for the bundling of DMRSes (e.g., DMRS TDW or DMRS bundling size), that is longer than a segment's length of compensation or pre-compensation; or (5) a maximum TDW size when the UE supports a TDW size for the bundling of DMRSes, that is longer than a segment's length of compensation or pre-compensation.

In some embodiments, the above capability may be combined. For example, (4) and (5) can be combined in same signaling (e.g., the UE may report the supported maximum DMRS TDW size when supporting DMRS TDW size longer than a segment's length together with whether the UE supports a TDW size to be longer than a segment's length. When the UE reports the supported maximum DMRS TDW size when supporting the DMRS TDW size longer than the segment's length, the capability information may implicitly indicate that the UE supports a DMRS TDW size longer than a segment's length. Moreover, the capability may contain multiple values corresponding to different scenarios. For example, in capability (5), the UE may report multiple maximum DMRS TDW size corresponding to different satellite orbit/elevation angles. When the UE is with a low elevation angle where timing drift fast, the supported maximum DMRS TDW size may be a small value. When the UE is with a high elevation angle where timing drift slowly, the supported maximum DMRS TDW size may be a larger value.

Moreover, for the capability (5), the UE may report the supported DMRS bundling size based on at least one of following methods: (i) directly report a DMRS TDW size with consideration of all possible scenarios; (ii) report a scaling factor with respect to a segment's length, wherein the DMRS TDW size can be the product of the segment's length and the scaling factor; (iii) report a differential value (e.g., a offset value) with respect to a segment's length, wherein the DMRS TDW size can be the sum of the segment's length and the differential value; or (iv) report a differential value (e.g., a offset value) with respect to a maximum DMRS TDW size without consideration of segment compensation (e.g., the segment-specific compensation or pre-compensation), wherein the DMRS TDW size can be maximum DMRS TDW size without consideration of segment compensation minus the differential value.

The capability (or assistance information) mentioned above may be reported via at least one of: a radio resource control (RRC) signaling or a medium control control element (MAC CE) signaling. The capability (4) and (5) (e.g., whether support the DMRS TDW size longer than the segment's length and the maximum DMRS TDW size when supporting the DMRS TDW size longer than the segment's length) may be reported after receiving the configuration of the segment's length, or before receiving the configuration of the segment's length. In some embodiments, the UE may send at least a portion of the assistance information after receiving a configuration of segments of the UL transmission, or before receiving the configuration of the segments, to the BS.

In some embodiments, a time domain window (TDW) can be an actual or a nominal TDW size of DMRS bundling. The nominal TDW may refer to a configuration length configured by the BS, which can be the expected length. The actual TDW may refer to an actual TDW smaller than the nominal TDW. When the nominal TDW is terminated due to certain events (e.g., a power adjustment), only the DMRS from the beginning of the TDW to the end of the TDW can be bundled. In such condition, the actual TDW can be performed. Therefore, the actual TDW can be used with caution. According to some definitions, the nominal TDW can be configured by the BS.

Based on above considerations, at least one of the following configuration methods of DMRS bundling may be supported for NTN:
(a) The actual or nominal TDW size of DMRS bundling can be determined based on UE capability signaling of enlarging TDW that crosses the UL transmission segments through a RRC signaling or a MAC CE signaling. The BS may determine the size of the TDW length and can configure the size of the TDW length to the UE.
(b) The actual or nominal TDW size of DMRS bundling can be determined based on the TDW size without consideration of segment compensation and segment's length of compensation both configured by the network. For example, the network may configure a large nominal TDW size which excludes influence of segment compensation and small segment's length of pre-compensation. The TDW size can be determined as the small segment's length.
(c) The actual or nominal TDW size of DMRS bundling can be determined based on a segment's length for compensation and a maximum DMRS TDW size when the UE supports a DMRS TDW longer than the segment's length indicated from the UE capability. When the UE capability of enlarging TDW that crosses the UL segments are enabled, and the corresponding time duration is indicated from the UE capability, the BS may determine the nominal DMRS TDW size as the time duration of UE capability, and may configure the nominal DMRS TDW size to the UE. Otherwise, the BS may determine the nominal DMRS TDW size as the segment's length, and can configure (e.g., determine and send as a configuration) the nominal DMRS TDW to the UE.
(d) The actual or nominal TDW size of DMRS bundling can be determined by the TDW size without consideration of segment compensation, segment's length for pre-compensation, and time duration indicated from UE capability. When the UE capability of enlarging TDW that crosses the UL transmission segments are enabled, and the configured DMRS bundling size without consideration of segment compensation is larger than time duration indicated from UE capability, a final DMRS bundling size can be equal to the time duration of UE capability. For example, L_{actualTDWsize}=min(L_{nominalTDWsize,config}, L_{timeduration,UEcapability}). The time duration (or size of TDW) of a UE can be signaled/indicated by a scaling factor of (or relative to) a segment's length, supplementary duration (e,g., a offset/differential value) of (or relative to) a segment's length, or a value of constant or variable time duration. For example, L_{timeduration,UEcapability}=SF*L_{segment}, or L_{timeduration,UEcapability}=L_{segment}+L_{delta}.
(e) The actual or nominal TDW size of DMRS bundling can be equal to a time duration reported by the UE capability/assistance signaling. As discussed above, the actual DMRS bundle size can be expected to be large but may not be expected to be larger than the segment's length of pre-compensation. Hence, directly setting the actual TDW size of DMRS bundling equal to the time duration of UE capability can be a suitable choice to enable a large DMRS bundling size with a better JCE gain.

In some embodiments, in order to support above functions, at least one of following functions may be supported:
(I) A time duration of DMRS bundling can be reported via UE capability of enlarging a TDW that crosses UL transmission segments, through/via a RRC signaling or a MAC CE signaling. The time duration of DMRS bundling can be at least one of followings: a scaling factor of the segment's length for pre-compensation, a supplementary duration based on the segment's length, or a constant or varied time duration determined by the UE capability.
(II) When time duration of DMRS bundling is reported by the UE capability signaling, the actual TDW size of DMRS bundling may be determined as/by at least one of the following: the nominal TDW size of DMRS bundling configured by the network regardless of time duration of the UE capability; the minimum value of nominal TDW size and the time duration of the UE capability; the time duration of the UE capability regardless of the nominal TDW size.

### Implementation Example 2: Trigger Method for Physical Uplink Control Channel (PUCCH) Repetition

In an initial access, 4-step RACH procedure can be applied. In msg4, a UE may receive a contention resolution information from a BS. The UE may transmit a hybrid automatic repeat request-acknowledgment (HARQ-ACK) for the msg4 to the BS in a physical uplink control channel (PUCCH) to confirm whether the msg4 is successfully received. In TN systems, a repetition of such PUCCH may not be supported. While in NTN systems, due to poor link budget, repetition of PUCCH for msg4 HARQ-ACK may need to be supported/used. Since repetition may not always be needed, determining when to trigger the PUCCH repetition for a msg4's HARQ-ACK can be considered.

A reference signal receiving power (RSRP) or a reference signal receiving quality (RSRQ) can be used to determine whether to trigger PUCCH for msg4 HARQ-ACK, which is used to mitigate poor coverage performance. At least one of following examples may be applied.

Example 1: A RSRP/RSRQ threshold can be predefined or configured from the network to the UE. The network configuration may comprise at least one of: system information block (SIB), a radio resource control (RRC) signaling, or a medium access control control clement (MAC CE) signaling. If the UE measured RSRP/RSRQ is lower than or equal to the threshold (or just lower than the threshold), the UE may indicate a request of repetition for PUCCH for msg4 HARQ-ACK to the network. Otherwise, the UE may not indicate the request, or may indicate that repetition for PUCCH for msg4 HARQ-ACK is not needed/requested.

Example 2: At least one RSRP/RSRQ threshold, which may correspond to at least one candidate repetition factor, can be predefined or configured from the network to the UE. For example, N thresholds {T₁<T₂< . . . <T_{N}} can be predefined or configured by the network, which may correspond to N candidate repetition factors {R₁, R₂, . . . , R_{N}} for PUCCH for msg4 HARQ-ACK, respectively. If the RSRP/RSRQ measured by the UE is lower than or equal to a threshold (or just lower than a threshold), the corresponding candidate repetition factor may be applied. If the UE's measured RSRP/RSRQ is larger than the largest threshold TN, repetition may not be triggered/needed. In such as case, the UE may not request a PUCCH repetition for msg4 HARQ-ACK, or may indicate that repetition is not needed to network. If the RSRP/RSRQ is smaller than Tₙ but larger than Tₙ₋₁, the UE may request the corresponding repetition factor Rₙ and may indicate the repetition factor Rₙ to the network.

Moreover, in NTN, the variation of the RSRP/RSRQ for UEs within one beam/cell can be small since a line-of-sight channel is dominant. The difference between RSRPs for UEs at beam/cell edge and center can be within 3 dB. As a result, the RSRP/RSRQ may not be appropriate parameters to determine whether repetition is needed. In order to better differentiate scenarios on whether repetition is needed in NTN, other parameters may be considered, including at least one of followings: an elevation angle, a distance between a UE and a satellite/high altitude platform station (HAPS), an ephemeris, a location of a satellite/HAPS, a location of a UE, or an altitude of a satellite/HAPS.

Similar to the utilization of RSRP/RSRQ, the following examples based on the above mentioned (or other) parameters may be applied.

Example 3: A threshold of elevation angle can be predefined or configured from the network to the UE. The network configuration may comprise at least one of: system information block (SIB), a radio resource control (RRC) signaling, or a medium access control control element (MAC CE) signaling. If an elevation angle of a UE is lower than or equal to the threshold (or just lower than the threshold), the UE may indicate a request of repetition for PUCCH for msg4 HARQ-ACK to the network. Otherwise, the UE may not indicate the request, or may indicate that repetition for PUCCH for msg4 HARQ-ACK is not needed/requested.

Example 4: A threshold of distance between a UE and a satellite/HAPS can be predefined or configured from the network to the UE. The network configuration may comprise at least one of: system information block (SIB), a radio resource control (RRC) signaling, or a medium access control control element (MAC CE) signaling. If a distance between the UE and the satellite/HAPS is larger than or equal to the threshold (or just larger than the threshold), the UE may indicate a request of repetition for PUCCH for msg4 HARQ-ACK to the network. Otherwise, the UE may not indicate the request, or may indicate that repetition for PUCCH for msg4 HARQ-ACK is not needed/requested.

Example 5: A threshold of altitude of a satellite/HAPS can be predefined or configured from the network to the UE. The network configuration may comprise at least one of: system information block (SIB), a radio resource control (RRC) signaling, or a medium access control control element (MAC CE) signaling. If an altitude of a satellite/HAPS is larger than or equal to the threshold (or just larger than the threshold), the UE may indicate a request of repetition for PUCCH for msg4 HARQ-ACK to the network. Otherwise, the UE may not indicate the request, or may indicate that a repetition for PUCCH for msg4 HARQ-ACK is not needed/requested.

Example 6: At least one elevation angle threshold, which may correspond to at least one candidate repetition factor, can be predefined or configured from the network to the UE. The network configuration may comprise at least one of: system information block (SIB), a radio resource control (RRC) signaling, or a medium access control control element (MAC CE) signaling. For example, N thresholds {T₁<T₂< . . . <T_{N}} can be predefined or configured by the network, which may correspond to N candidate repetition factors {R₁, R₂, . . . , R_{N}} for PUCCH for msg4 HARQ-ACK, respectively. If an elevation angle at the UE is lower than or equal to a threshold (or just lower than a threshold), the corresponding candidate repetition factor may be applied. If an elevation angle at the UE is larger than largest threshold Tₙ, a repetition may not be triggered. The UE may not request a PUCCH repetition for msg4 HARQ-ACK, or may indicate repetition is not needed to network. If an elevation angle is smaller than Tₙ but larger than Tₙ₋₁, the UE may request the repetition factor Rₙ and may indicate the repetition factor Rₙ to the network.

Example 7: At least one distance (between a UE and a satellite/HAPS) threshold, which may correspond to at least one candidate repetition factor, can be predefined or configured from the network to the UE. The network configuration may comprise at least one of: system information block (SIB), a radio resource control (RRC) signaling, or a medium access control control element (MAC CE) signaling. For example, N thresholds {T₁>T₂> . . . >T_{N}} can be predefined or configured by the network, which may correspond to N candidate repetition factors {R₁, R₂, . . . , R_{N}} for PUCCH for msg4 HARQ-ACK, respectively. If a distance (between a UE and a satellite/HAPS) is larger than or equal to a threshold (or just larger than a threshold), the corresponding candidate repetition factor may be applied. If a distance (between a UE and a satellite/HAPS) is smaller than a minimum threshold T_{N}, repetition may not be triggered/needed. The UE may not request a PUCCH repetition for msg4 HARQ-ACK, or may indicate that repetition is not needed to network. If a distance (between a UE and a satellite/HAPS) is larger than Tₙ but smaller than Tₙ₋₁, the UE may request the repetition factor Rₙ and may indicate the repetition factor Rₙ to the network.

Example 8: At least one altitude (of satellite/HAPS) threshold, which may correspond to at least one candidate repetition factor, can be predefined or configured from the network to the UE. The network configuration may comprise at least one of: system information block (SIB), a radio resource control (RRC) signaling, or a medium access control control element (MAC CE) signaling. For example, N thresholds {T₁>T₂> . . . >T_{N}} can be predefined or configured by the network, which may correspond to N candidate repetition factors {R₁, R₂, . . . , R_{N}} for PUCCH for msg4 HARQ-ACK, respectively. If an altitude (of satellite/HAPS) is higher than or equal to a threshold (or just higher than a threshold), the corresponding candidate repetition factor may be applied. If an altitude (of satellite/HAPS) is lower than a minimum threshold TN, repetition may not be triggered/needed. The UE may not request a PUCCH repetition for msg4's corresponding HARQ-ACK, or may indicate that repetition is not needed to the network. If an altitude (of satellite/HAPS) is higher than Tₙ but lower than Tₙ₋₁, the UE may request the repetition factor Rₙ and may indicate the repetition factor Rₙ to the network.

It should be understood that one or more features from the above implementation examples are not exclusive to the specific implementation examples, but can be combined in any manner (e.g., in any priority and/or order, concurrently or otherwise).

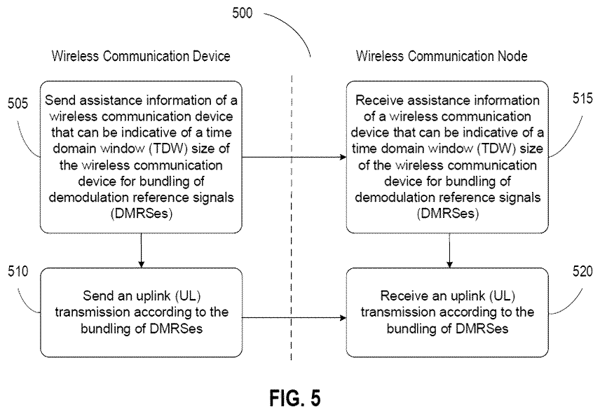

FIG. 5 illustrates a flow diagram for coverage enhancement in non-terrestrial network (NTN), in accordance with an embodiment of the present disclosure. The method 500 may be implemented using any one or more of the components and devices detailed herein in conjunction with FIGS. 1-2. In overview, the method 500 may be performed by a wireless communication device, in some embodiments. Additional, fewer, or different operations may be performed in the method 500 depending on the embodiment. At least one aspect of the operations is directed to a system, method, apparatus, or a computer-readable medium.

A wireless communication device (e.g., a user equipment (UE)) may send assistance information of the wireless communication device that is indicative of a time domain window (TDW) size of the wireless communication device for bundling of demodulation reference signals (DMRSes) (e.g., includes a DRMS TDW size itself, or include information that can be used to determine the DMRS TDW size) to a wireless communication node (e.g., a base station (BS)). The wireless communication device may send an uplink (UL) transmission according to the bundling of DMRSes to the wireless communication node.

In some embodiments, the assistance information may include at least one of: capability information of the wireless communication device that can be indicative of the TDW size of the wireless communication device for the bundling of DMRSes; or an indication of the TDW size for the bundling of DMRSes. The capability information may include, for all scenarios or for each of one or more scenarios, a respective indication of at least one of: whether the wireless communication device supports segment-specific compensation (e.g., specific to each segment) or pre-compensation (e.g., on a per-segment basis) using at least one of: timing advance (TA) or frequency adjustment; whether the wireless communication device supports the bundling of DMRSes across multiple segments of the UL transmission, over a length (e.g., a time duration) that is indicated (e.g., configured) by the wireless communication node; whether the wireless communication device supports the bundling of DMRSes; a maximum TDW size without consideration of/independent of/regardless of the segment-specific compensation or pre-compensation; whether the wireless communication device supports a TDW size for the bundling of DMRSes (e.g., DMRS TDW or DMRS bundling size), that is longer than a segment's length of compensation or pre-compensation; or a maximum TDW size when the wireless communication device supports a TDW size for the bundling of DMRSes, that is longer than a segment's length of compensation or pre-compensation. Different scenarios can be determined, for example, according to a distance between a satellite and a UE, or a speed of a satellite.

In some embodiments, sending the assistance information may comprise sending the assistance information using one or more transmissions. The one or more transmissions may comprise at least one of: a radio resource control (RRC) signaling or a medium access control control element (MAC CE) signaling. The indication of the TDW size for the bundling of DMRSes may include at least one of: a TDW size for the bundling of DMRSes for all scenarios; a scaling factor with respect to a segment's length, wherein the TDW size for the bundling of DMRSes is a product of the scaling factor and the segment's length; a first offset value (e.g., a differential value) with respect to a segment's length, wherein the TDW size for the bundling of DMRSes is a sum of the first offset value and the segment's length; or a second offset value with respect to the maximum TDW size without consideration of the segment-specific compensation or pre-compensation, wherein the TDW size for the bundling of DMRSes is a sum of the second offset value and the maximum TDW size without consideration of the segment-specific compensation or pre-compensation.

In some embodiments, the wireless communication device may send at least a portion of the assistance information after receiving a configuration of segments of the UL transmission, or before receiving the configuration of the segments, to the wireless communication node. In certain embodiments, the configuration of the segments can be determined according to at least some portion of the assistance information.

In some embodiments, the wireless communication device may determine the TDW size for the bundling of DMRSes, according to at least one of: the assistance information (e.g., which can indicate a time duration of UE capability), a nominal TDW size configured by the wireless communication node; or a segment's length of compensation or pre-compensation, configured by the wireless communication node. The wireless communication device may receive a configuration of segments of the UL transmission (e.g., a configuration of segment length(s)) from the wireless communication node. The wireless communication device may perform compensation or pre-compensation for the uplink transmission for each of the segments (e.g., specific to each segment).

In some embodiments, the wireless communication device may receive, from the wireless communication node, at least one of: a confirmation to use at least a portion of the assistance information from the wireless communication device, in relation to the UL transmission; a confirmation to use the TDW size indicated in the assistance information, in relation to the UL transmission; or an indication of the TDW size, that is different from or same as the TDW size indicated in the assistance information, to use in relation to the UL transmission. The wireless communication device may transmit the UL transmission according to the TDW size (e.g., using the TDW size, or in relation to/with the TDW size) to the wireless communication node. When the TDW size indicated by wireless communication device is larger than a segment's length configured by the wireless communication node, the wireless communication device can be to ensure consistency between adjacent segments of the UL transmission that are within a corresponding TDW (e.g., in compensation/pre-compensation).

In some embodiments, the wireless communication node (e.g., a BS) may receive assistance information of the wireless communication device that can be indicative of a time domain window (TDW) size of the wireless communication device for bundling of demodulation reference signals (DMRSes) from a wireless communication device (e.g., a UE). The wireless communication node may receive an uplink (UL) transmission according to the bundling of DMRSes from the wireless communication device.

In some embodiments, a wireless communication device may compare a metric (e.g., a reference signal receiving power (RSRP), a reference signal receiving quality (RSRQ), an elevation angle, or a distance) relative to one or more thresholds; and at least one of: determining, by the wireless communication device according to the comparing, whether and/or what repetition of a transmission (e.g., hybrid automatic repeat request-acknowledgment (HARQ-ACK) for msg4) in a physical uplink control channel to the wireless communication node, is desired; determining, by the wireless communication device according to the comparing, whether to indicate to the wireless communication node whether and/or what repetition is desired for the transmission; or sending, by the wireless communication device to the wireless communication node, an indication of whether and/or what repetition is desired for the transmission.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims bel

[symbol]

What is claimed is:

1. A method comprising:
sending, by a wireless communication device to a wireless communication node, assistance information of the wireless communication device that is indicative of a time domain window (TDW) size of the wireless communication device for bundling of demodulation reference signals (DMRSes); and
sending, by the wireless communication device to the wireless communication node, an uplink (UL) transmission according to the bundling of DMRSes.

2. The method of claim 1, wherein, the assistance information includes at least one of:
capability information of the wireless communication device that is indicative of the TDW size of the wireless communication device for the bundling of DMRSes; or
an indication of the TDW size for the bundling of DMRSes.

3. The method of claim 2, wherein the capability information includes, for all scenarios or for each of one or more scenarios, a respective indication of at least one of:
whether the wireless communication device supports segment-specific compensation or pre-compensation using at least one of: timing advance (TA) or frequency adjustment;
whether the wireless communication device supports the bundling of DMRSes across multiple segments of the UL transmission, over a length that is indicated by the wireless communication node;
whether the wireless communication device supports the bundling of DMRSes;
a maximum TDW size without consideration of the segment-specific compensation or pre-compensation;
whether the wireless communication device supports a TDW size for the bundling of DMRSes, that is longer than a segment's length of compensation or pre-compensation; or
a maximum TDW size when the wireless communication device supports a TDW size for the bundling of DMRSes, that is longer than a segment's length of compensation or pre-compensation.

4. The method of claim 1, wherein sending the assistance information comprises sending the assistance information using one or more transmissions.

5. The method of claim 4, wherein the one or more transmissions comprise at least one of: a radio resource control (RRC) signaling or a medium access control control element (MAC CE) signaling.

6. The method of claim 2, wherein the indication of the TDW size for the bundling of DMRSes includes at least one of:
a TDW size for the bundling of DMRSes for all scenarios;
a scaling factor with respect to a segment's length, wherein the TDW size for the bundling of DMRSes is a product of the scaling factor and the segment's length;
a first offset value with respect to a segment's length, wherein the TDW size for the bundling of DMRSes is a sum of the first offset value and the segment's length; or
a second offset value with respect to the maximum TDW size without consideration of the segment-specific compensation or pre-compensation, wherein the TDW size for the bundling of DMRSes is a sum of the second offset value and the maximum TDW size without consideration of the segment-specific compensation or pre-compensation.

7. The method of claim 1, comprising:
sending, by the wireless communication device to the wireless communication node, at least a portion of the assistance information after receiving a configuration of segments of the UL transmission, or before receiving the configuration of the segments.

8. The method of claim 7, wherein the configuration of the segments is determined according to at least some portion of the assistance information.

9. The method of claim 1, comprising:
determining, by the wireless communication device, the TDW size for the bundling of DMRSes, according to at least one of:
the assistance information,
a nominal TDW size configured by the wireless communication node; or
a segment's length of compensation or pre-compensation, configured by the wireless communication node.

10. The method of claim 1, comprising:
receiving, by the wireless communication device from the wireless communication node, a configuration of segments of the UL transmission.

11. The method of claim 10, comprising:
performing, by the wireless communication device, compensation or pre-compensation for the uplink transmission for each of the segments.

12. The method of claim 1, comprising:
receiving, by the wireless communication device from the wireless communication node, at least one of:
a confirmation to use at least a portion of the assistance information from the wireless communication device, in relation to the UL transmission;
a confirmation to use the TDW size indicated in the assistance information, in relation to the UL transmission; or
a indication of the TDW size, that is different from or same as the TDW size indicated in the assistance information, to use in relation to the UL transmission.

13. The method of claim 1, comprising:
transmitting, by the wireless communication device to the wireless communication node, the UL transmission according to the TDW size.

14. The method of claim 1, wherein when the TDW size indicated by wireless communication device is larger than a segment's length configured by the wireless communication node, the wireless communication device is to ensure consistency between adjacent segments of the UL transmission that are within a corresponding TDW.

15. A method comprising:
receiving, by a wireless communication node from a wireless communication device, assistance information of the wireless communication device that is indicative of a time domain window (TDW) size of the wireless communication device for bundling of demodulation reference signals (DMRSes); and
receiving, by the wireless communication node from the wireless communication device, an uplink (UL) transmission according to the bundling of DMRSes.

16. A wireless communication node comprising:
at least one processor configured to:
receive, via a receiver from a wireless communication device, assistance information of the wireless communication device that is indicative of a time domain window (TDW) size of the wireless communication device for bundling of demodulation reference signals (DMRSes); and
receive, via the receiver from the wireless communication device, an uplink (UL) transmission according to the bundling of DMRSes.

17. A wireless communication device, comprising:
at least one processor configured to:
send, via a transmitter to a wireless communication node, assistance information of the wireless communication device that is indicative of a time domain window (TDW) size of the wireless communication device for bundling of demodulation reference signals (DMRSes); and
send, via the transmitter to the wireless communication node, an uplink (UL) transmission according to the bundling of DMRSes.

18. The wireless communication device of claim 17, wherein, the assistance information includes at least one of:
capability information of the wireless communication device that is indicative of the TDW size of the wireless communication device for the bundling of DMRSes; or
an indication of the TDW size for the bundling of DMRSes.

19. The wireless communication device of claim 18, wherein the capability information includes, for all scenarios or for each of one or more scenarios, a respective indication of at least one of:
whether the wireless communication device supports segment-specific compensation or pre-compensation using at least one of: timing advance (TA) or frequency adjustment;
whether the wireless communication device supports the bundling of DMRSes across multiple segments of the UL transmission, over a length that is indicated by the wireless communication node;
whether the wireless communication device supports the bundling of DMRSes;
a maximum TDW size without consideration of the segment-specific compensation or pre-compensation;
whether the wireless communication device supports a TDW size for the bundling of DMRSes, that is longer than a segment's length of compensation or pre-compensation; or
a maximum TDW size when the wireless communication device supports a TDW size for the bundling of DMRSes, that is longer than a segment's length of compensation or pre-compensation.

20. The wireless communication device of claim 17, wherein to send the assistance information comprises to send the assistance information using one or more transmissions.
